(19) United States
(12) Patent Application Publication
(10) Pub. No.: US 2005/0252851 A1
(43) Pub. Date: Nov. 17, 2005

(54) Filter and method of forming a filter

(76) Inventors: Nicholas R. Mann, Blackfoot, ID (US); R. Scott Herbst, Idaho Falls, ID (US); Vadim Kochergin, Twin Falls, ID (US); Tammy L. Trowbridge, Idaho Falls, ID (US)

Correspondence Address: Stephen R. Christian;BBWI, PO BOX 1625, IDAHO FALLS, ID, 83415-3899, US

(21) Appl. No.: 10/848,482

(22) Filed: May 17, 2004

(51) Int. Cl. B01D 29/50

(52) U.S. Cl. 210/490; 210/510.1; 55/523; 55/482

(57) ABSTRACT

A filter and method of forming a filter is described and which includes a porous inorganic substrate having a plurality of pores, and which permits the passage of a fluid therethrough, and a ceramic filtration media formed of particles having a particle size which permits the ceramic filtration media to be embedded in at least some of the porous inorganic substrate and positioned at and/or below the top surface of the inorganic substrate.

### GOVERNMENT RIGHTS

The United States government has rights in the following invention pursuant to Contract No. DE-AC07-99ID13727 between the U.S. Department of Energy and Bechtel BWXT Idaho, LLC.

### TECHNICAL FIELD

The present invention relates to a filter and method of forming a filter, and more specifically to a novel filter which includes a ceramic filtration media which is embedded in at least some of the pores of a porous inorganic substrate.

### BACKGROUND OF THE INVENTION

Various filters and methods of forming filters have been utilized through the years. Such filters have been employed in assorted commercial applications to provide filtrates having various amounts of solids which are suspended therein.

With respect to crop-based renewable resources, that is, cellulosic biomass such as straw, corn, stover, wood, beet and fruit juice, and fermentation stock, it has long been known that these are excellent resources for conversion into chemicals and fuels. These same products are now being more carefully developed by the ever evolving biomass conversion industry. However, these types of feed stock often contain high amounts of suspended solids, and have a wide range of particle consistencies. In the biomass industry, it has been understood that ultrafiltration of these feed streams is typically required. However, this processing has been viewed as difficult, inefficient and costly, due in part to the abrasive nature of the feed stock, and the subsequent failure of the filter membranes when exposed to these same feed stocks. Additionally, the initial capital costs of installing a filtration plant of the type needed to provide the ultrafiltration is unusually cost prohibitive. Some research and development has been initiated to develop new filter designs for the biomass conversion industry using conventional filtration technology, however, those efforts have not borne any fruit as of late. A problem still remains regarding the erosion of filters, when exposed to abrasive feed stocks such as discussed above. Therefore, a filter and method of forming a filter which addresses the perceived problems attendant with the prior art filters which have been utilized heretofore is the subject matter of the present application.

### SUMMARY OF THE INVENTION

A first aspect of the present invention relates to a filter which includes a porous inorganic substrate having a plurality of pores, and which permits the passage of a fluid therethrough; and a ceramic filtration media formed of particles having a particle size which permits the ceramic filtration media to be embedded in at least some of the pores of the porous inorganic substrate.

Yet another aspect of the present invention relates to a filter which includes an inorganic substrate having a top surface, and which has a plurality of pores located at the top surface, and which permits the passage of a fluid through the inorganic substrate, and wherein the top surface is exposed to a fluid which is to be filtered; and a ceramic filtration media having particles with an average size which will permit at least some of the particles to become embedded in the pores which are located at the top surface of the inorganic substrate, and wherein the embedded ceramic filtration media is positioned at and/or below the top surface of the inorganic substrate.

Still further, another aspect of the present invention relates to a filter which includes an inorganic substrate having a top surface and a first degree of toughness, and which is fabricated from an inorganic material having particles which have an average size, and which forms a matrix, and wherein the matrix of inorganic material defines a plurality of pores which are located on the top surface of the inorganic substrate, and which have an average pore diameter, and which further facilitates the passage of a fluid to be filtered through the inorganic substrate; a ceramic filtration media formed of particles having an average size which are smaller than the average pore diameter as defined by the particles forming the inorganic substrate, and which further has a second degree of toughness, and wherein the particles forming the ceramic filtration media are embedded in the pores of the inorganic substrate which are located at the top surface, and wherein the ceramic filtration media fills the pores from a location which is at, and/or below the top surface of the inorganic substrate to a distance, and wherein the inorganic substrate substantially impedes the erosion of the ceramic filtration media when the filter is exposed to a feed stream which requires filtration.

Another aspect of the present invention relates to a method of forming a filter and which includes the steps of providing an inorganic substrate having a first toughness and which will resist degradation when exposed to a fluid to be filtered, and wherein the inorganic substrate is further defined by a top surface; and embedding a ceramic filtration media having a second predetermined toughness into the inorganic substrate so as to substantially inhibit the degradation of the ceramic filtration media when the filter is exposed to the fluid to be filtered.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly enlarged, and simplified depiction of a prior art filter.

FIG. 2 is a greatly enlarged, and simplified depiction of one form of the filter of the present invention.

FIG. 3 is a greatly enlarged, and simplified depiction of a second form of the filter of the present invention.

FIG. 4 is a greatly enlarged, and simplified depiction of a first step in the method of forming a filter of the present invention.

FIG. 5 is a greatly enlarged, and simplified depiction of a second step in the methodology of forming a filter of the present invention.

FIG. 6 is a greatly enlarged, and simplified depiction of a third step in the methodology of forming a filter of the present invention.

FIG. 7 is a greatly enlarged, and simplified depiction of a fourth step in the methodology of forming a filter of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

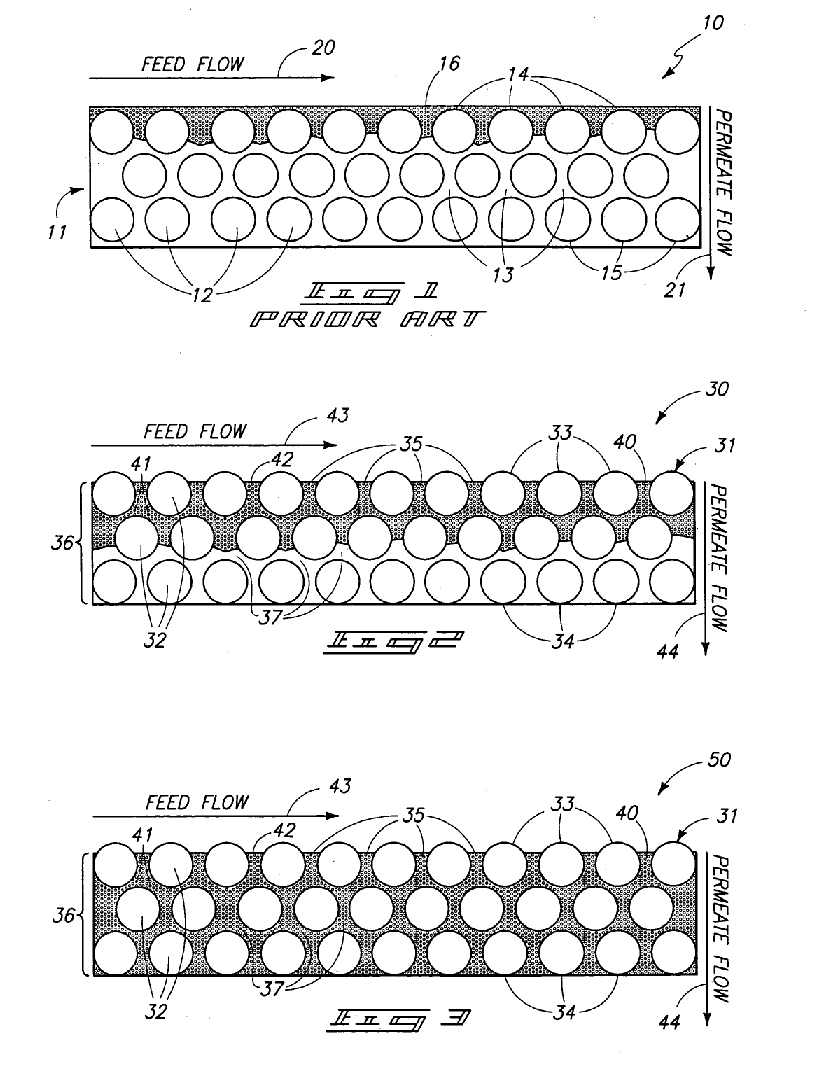

A prior art filter 10 is shown in the very greatly enlarged and simplified view of FIG. 1. As seen therein, the prior art filter 10 includes a porous substrate which is generally indicated by the numeral 11, and which includes a plurality of particles or other structures 12 which form a matrix, and which define various passageways 13 and which extend between the top surface 14 and the bottom surface 15. Still further, a filtration media 16 is deposited on and positioned generally above the top surface 14, and is operable to provide the means by which suspended particles in the feed flow 20 can be separated therefrom in order to provide an acceptable permeate flow 21 through the porous substrate 11.

Referring now to FIG. 2, a first form of the filter of the present invention is generally indicated by the numeral 30, and includes a porous inorganic substrate 31 which may be fabricated from materials such as stainless steel, and the like, and which includes a plurality of particles 32 which form a matrix having a top surface 33 and a bottom surface 34. The inorganic substrate has a first degree of toughness. The matrix which is formed by the particles defines a plurality of pores 35 which are located at the top surface 33 of the inorganic substrate 31 and which facilitate the passage of a fluid to be filtered through the inorganic substrate. The plurality of pores have an average diameter which is greater than the particle size of the ceramic filtration media. The ceramic filtration media will be discussed, below. As should be understood, the inorganic substrate has an amount of ductility which will be restrained by the construction of the filter as will be discussed below. The first form of the filter has a thickness dimension which is generally indicated by the numeral 36, and the matrix formed by the plurality of particles 32 defines a plurality of passageways 37 which extend from the individual pores 35 which are located at the top surface 33, to the bottom surface 34.

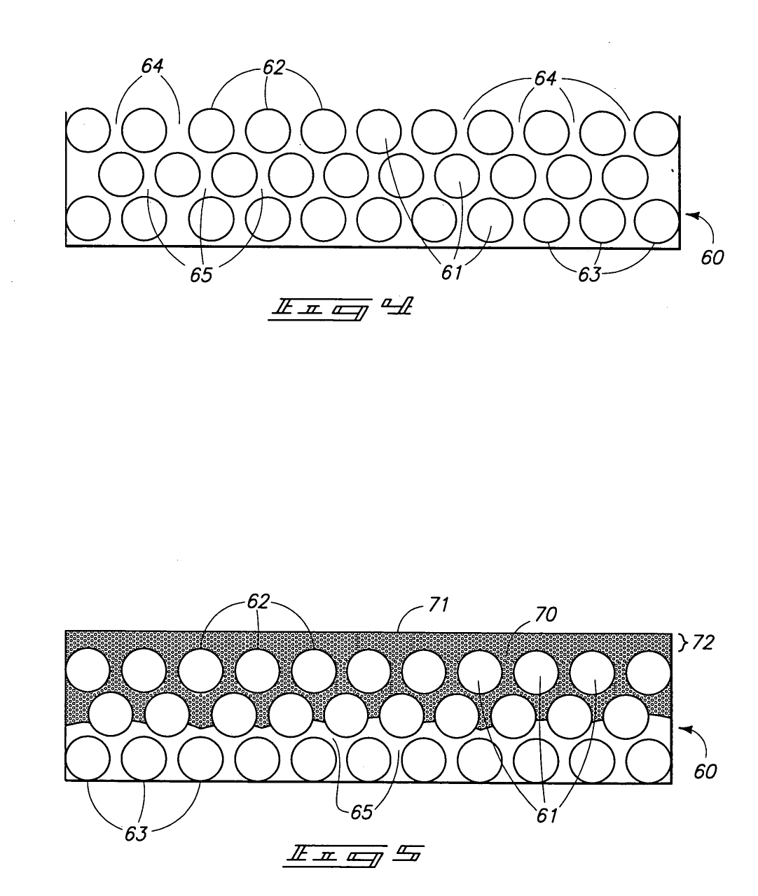

As seen in FIG. 2, a ceramic filtration media 40 which is formed of particles 41 having a size which are smaller than the average pore diameter, and which is defined by the particles 32 is provided. The ceramic filtration media 40 has a second degree of toughness and wherein the first degree of toughness of the inorganic substrate is greater than the second degree of toughness as exhibited by the ceramic filtration media. However, it should be understood that the first and second degrees of toughness are chosen so as to provide a resulting filter 30 which impedes the erosion of the ceramic filtration media 40. Still further, in the arrangement as shown in FIG. 2, the ceramic filtration media 40, as chosen, restrains the amount of ductility expressed by the inorganic substrate thereby imparting a degree of erosion resistance to the filter 30. The ceramic filtration media 40 which is chosen is selected from the group comprising a material formed of a single or multiple substantially stable metallic cation species having single or multiple oxide, carbide and/or nitride anion counterparts. When the inorganic substrate 31 comprises stainless steel, the ceramic filtration media may be selected from the group comprising aluminum oxide, titanium oxide, and zirconium oxide. As noted above, the inorganic substrate 31 has a predetermined thickness dimension 36, and the ceramic filtration media 40 is positioned at a depth at and/or below the top surface 33, and is further less than about 20% of the predetermined thickness dimension 36. This penetration of the ceramic filtration media 40 may be in a range of distances to and including a distance which is at least a preponderance of the predetermined thickness dimension, or as seen at the second form of the invention as depicted in FIG. 3, to substantially 100% of the thickness dimension 36 of the porous inorganic substrate 31.

The filtration media 40 has a top surface 42 which is positioned substantially at and/or below the top surface 33 of the porous inorganic substrate 31, and is exposed to a feed flow 43. A permeate flow 44 results, and which passes through the filtration media 40 as seen in FIGS. 2 and 3, respectively. The second form of the invention, as noted above, is generally indicated by the numeral 50 in FIG. 3, and depicts an inorganic substrate 31 having a filtration media 40, and wherein the filtration media penetrates to substantially 100% of the thickness dimension 36 of the inorganic substrate 31. As will be discussed in greater detail below, the ceramic filtration media 40 is embedded in the inorganic substrate 31 by forming a slurry of the ceramic filtration media 40, and then casting same onto the top surface 33 of the inorganic substrate 31.

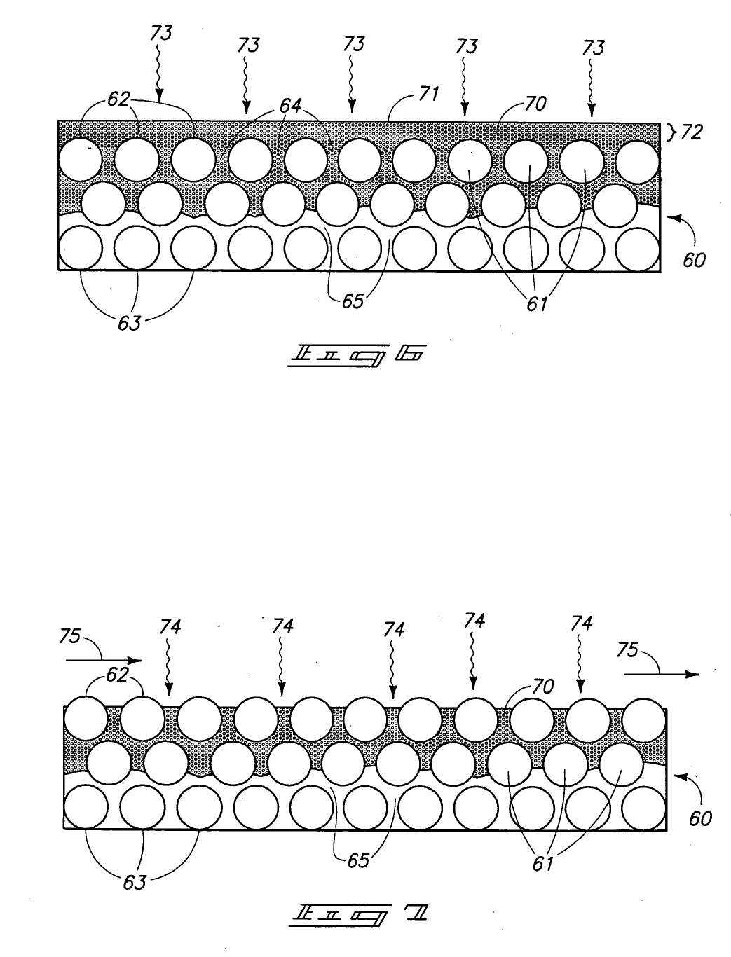

The method of forming a filter of the present invention is best understood by a study of FIGS. 4-7, respectively. As seen in FIG. 4, in the method of forming a filter of the present invention, a porous inorganic substrate 60 is selected and which includes a plurality of particles 61 which form a matrix and which has a top surface 62, and a bottom surface 63. The matrix defines a plurality of pores 64 at the top surface thereof, and which have an average pore diameter. The respective pores 64 lead to a plurality of passageways 65, which allow for the passage of a fluid to be filtered through the matrix and out the bottom surface 63 thereof. In this first step of the method of forming a filter of the present invention, a first porous inorganic substrate 60 having a predetermined first toughness is provided, and which will resist degradation when exposed to a fluid to be filtered. In a second step, as seen most clearly in FIG. 5, a ceramic filtration media 70 is selected and which has a particle size which will easily pass into the porous inorganic substrate and be embedded a distance therein. The filtration media 70 is selected from the group comprising a material formed of a single or multiple substantially stable metallic cation species having single or multiple oxide carbide and/or nitride anion counterparts. In the method as seen in FIG. 5, a slurry of the ceramic filtration media 70 is formed, and is stabilized in a solution containing, but not limited to water; alcohol; (long and short chain); benzene derivatives; (toluene, and phenol, etc.); ketones; including methyl ethyl ketone; ethers; aliphatic compounds (oils and hexane); amines and its variations (pyridine and ammonia, for example) or any combinations of the foregoing. With the solution noted above, surfactants, binders and anti-foaming agents can be added for the stabilization of the filtration media in the resulting slurry. Surfactants that can be used successfully include but are not limited to anionic, cationic, and non-ionic types. Binders which may be included in the slurry may include, but are not limited to, polymeric bead suspensions, inorganic or organic salts, or long organic chain material such as methyl cellulose. Any combination of the materials, noted above, are used to create a stable fully suspended slurry with a total weight percent of solids which may be in a range of about 0 to about 80 weight percent.

After forming the slurry of ceramic filtration media 70, the method of the present invention includes a next step of casting the slurry, so formed, onto the top surface of the inorganic substrate as seen in FIG. 5, and under conditions which facilitate the penetration of the ceramic filtration media 70 to a distance at and/or below the top surface 62 of the inorganic substrate 61. As seen in FIG. 5, the filtration media 70, following casting, has a top surface 71, which is positioned above the top surface 62 of the porous inorganic substrate 60. In the arrangement as shown in FIG. 5, the step of casting the slurry on the top surface 62 of the inorganic substrate 60 further includes utilizing a casting technique which is selected from the group comprising slip casting, pressure casting, and painting or combinations thereof.

Referring now to FIG. 6, after the step of casting the slurry onto the top surface 62 of the inorganic substrate 60, the methodology of the present invention further includes drying the inorganic substrate. The inorganic substrate maybe dried by exposing it to a source of heat as indicated by the numeral 73, or by exposing it to a flow of air which causes an evaporation of the components comprising the slurry.

Referring now to FIG. 7, after the step of drying the inorganic substrate 60 as seen in FIG. 6, the method of the present invention further includes removing any excess ceramic filtration media 70 which is located above the top surface 62 of the porous inorganic substrate 60. This step of removing the excess ceramic filtration media maybe accomplished by means of wet and/or dry extrusion, scarping and/or buffing. After the step of removing any excess ceramic filtration media, the method includes another step of exposing the resulting inorganic substrate and embedded ceramic filtration media 70 to a predetermined temperature in the form of heat 74 to effect sintering, and/or annealing of the ceramic filtration media 70. With respect to the step of exposing the resulting inorganic substrate 60 to a predetermined temperature in the form of heat 74, the methodology further includes an additional step of supplying a cover gas 75 which is selected from the group of gasses comprising inert, oxidizing, reducing or combinations thereof, and which are present during the annealing, or sintering as seen in FIG. 7.

### Operation

The operation of the described embodiments of the present invention are believed to be readily apparent and are briefly summarized at this point.

A filter 30, or 50 of the present invention includes a porous inorganic substrate 31 having a plurality of pores 35, and which permits the passage of a fluid 44 therethrough; and a ceramic filtration media 40 formed of particles 41 having a size which permits the ceramic filtration media to be embedded in at least some of the pores of the porous inorganic substrate. As seen in FIGS. 2 and 3, the porous inorganic substrate is formed of particles 12 which forms a matrix, and which has a first degree of toughness. As seen in FIG. 2, the ceramic filtration media 40 penetrates to a depth which is less than about 20% of the thickness dimension 36. As seen in FIG. 3, a second form of the invention 50 is shown, and wherein the filtration media 40 penetrates to at least 100% of the thickness dimension 36 of the porous inorganic substrate. As noted above, the ceramic filtration media 40 is embedded in at least some of the pores 35 by a casting technique.

In another aspect of the invention, a filter 30 or 50 is provided and which includes a porous inorganic substrate 31 having a top surface 33 and which has a plurality of pores 35 located at the top surface. The pores permit the passage of a fluid 44 through the porous inorganic substrate. The top surface 33 is exposed to a fluid 43 which is to be filtered. A ceramic filtration media 40 is provided, and which has particles 41 with an average size which will permit at least some of the particles to become embedded in the pores 35 which are located at the top surface 33, of the porous inorganic substrate 31. As seen in FIGS. 2 and 3, the ceramic filtration media is positioned at and/or below the top surface 33 of the porous inorganic substrate. In the arrangement as shown in FIGS. 2 and 3, the porous inorganic substrate 31 is formed of particles having an average particle size which is greater than the particle size of the ceramic filtration media 40. The porous inorganic substrate which is provided forms a ductile matrix. Still further, and as earlier discussed, the toughness of the inorganic substrate 31, and the ceramic filtration media 40 are selected in order to provide a resulting filter 30, and 50 which is resistant to erosion when exposed to a feed flow 43.

In the method of the present invention as seen in FIGS. 4-7, respectively, the method of forming a filter generally includes a first step of providing a porous inorganic substrate 60 having a predetermined first toughness and which will resist degradation when exposed to a fluid to be filtered, and wherein the porous inorganic substrate is further defined by a top surface 62. Still further, the method includes embedding a ceramic filtration media 70 having a second predetermined toughness into the porous inorganic substrate 60 so as to substantially inhibit the degradation of the ceramic filtration media when the resulting filter is exposed to the fluid to be filtered. In connection with the step of embedding the ceramic filtration media, the method further comprises selecting a ceramic filtration media 70 having a particle size which will pass into the porous substrate 61; and forming a slurry of the of ceramic filtration media and casting the slurry onto the top surface of the inorganic substrate under conditions which facilitate the penetration of ceramic filtration media 70 to a distance at and/or below the top surface 62 of the porous inorganic substrate 60.

In the method of the present invention, the step of casting the slurry onto the top surface 62 of the inorganic substrate 60 further includes utilizing a casting technique which is selected from the group comprising slip casting, pressure casting and painting. Still further, the step of casting the slurry onto the top surface of the inorganic substrate 60, further includes the steps of drying 73 the inorganic substrate 60; removing any excess ceramic filtration media 70 which is located above the top surface 62 of the inorganic substrate 60; and exposing the resulting inorganic substrate 60 and embedded ceramic filtration media 70 to a predetermined temperature to effect sintering and/or annealing 74 as seen in FIG. 7. Yet further, the step of exposing the resulting inorganic substrate and embedded ceramic filtration media 70 to a predetermined temperature to effect annealing, further comprises supplying a cover gas 75 which is selected from the group of gases comprising inert, oxidizing, reducing or combinations thereof.

The present filter and method of forming a filter has numerous advantages over the prior art filters and the methodology utilized heretofore. More specifically, the methodology provides a resulting filter which substantially resists erosion when exposed to feed stocks which could abrade or otherwise damage the filtration media if the filtration media 70 was positioned above the top surface of the supporting porous matrix as was the practice of the prior art as seen in FIG. 1. Another advantage is increased flux, or increased rate of flow of solution through the resulting membrane by removing the filtration media 70 positioned above the top surface of the supporting porous matrix.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A filter, comprising:
an inorganic substrate having a plurality of pores, and which permits the passage of a fluid therethrough; and
a ceramic filtration media formed of particles having a particle size which permits the ceramic filtration media to be embedded in at least some of the pores of the inorganic substrate.

2. A filter as claimed in claim 1, and wherein the inorganic substrate has a given amount of ductility, and wherein the ceramic filtration media restrains, at least in part, the given amount of ductility expressed by the inorganic substrate.

3. A filter as claimed in claim 1, and wherein the inorganic substrate has a top surface, and wherein the ceramic filtration media is positioned at and/or below the top surface of the inorganic substrate.

4. A filter as claimed in claim 1, and wherein the inorganic substrate has a predetermined thickness dimension, and wherein the ceramic filtration media penetrates to a depth of about 100% of the thickness of the inorganic substrate.

5. A filter as claimed in claim 1, and wherein the ceramic filtration media is selected from the group comprising a material formed of a single or multiple substantially stable metallic cation species having single or multiple oxide, carbide and/or nitride anion counterparts.

6. A filter as claimed in claim 1, and wherein the inorganic substrate is formed of particles which forms a matrix, and wherein the inorganic substrate further impedes, at least in part, the erosion of the ceramic filtration media when the filter is exposed to feed stream which requires filtration.

7. A filter as claimed in claim 1, and wherein the inorganic media has a top surface and a predetermined thickness dimension, and wherein the ceramic filtration media penetrates to a depth which is less than about 20% of the thickness dimension, and wherein the ceramic filtration media is positioned at and/or below the top surface of the inorganic media.

8. A filter as claimed in claim 1, and wherein the inorganic substrate, and the ceramic filtration media each have a different degree of toughness.

9. A filter as claimed in claim 1, and wherein the ceramic filtration media is embedded in at least some of the pores of the inorganic substrate by a casting technique.

10. A filter as claimed in claim 1, and wherein the inorganic substrate comprises stainless steel, and the ceramic filtration media is selected from the group comprising aluminum oxide, titanium oxide, or zirconium oxide.

11. A filter, comprising:
an inorganic substrate having a top surface, and which has a plurality of pores located at the top surface, and which permits the passage of a fluid through the inorganic substrate, and wherein the top surface is exposed to a fluid which is to be filtered; and
a ceramic filtration media having particles with an average size which will permit at least some of the particles to become embedded in the pores which are located at the top surface of the inorganic substrate, and wherein the embedded ceramic filtration media is positioned at and/or below the top surface of the inorganic substrate.

12. A filter as claimed in claim 11, and wherein the inorganic substrate is formed of particles having an average particle size which is greater than the particle size of the ceramic filtration media, and wherein the particles of the inorganic substrate form a ductile matrix.

13. A filter as claimed in claim 11, and wherein the ceramic filtration media is embedded into the pores of the inorganic substrate by forming a slurry of the ceramic filtration media, and then subsequently casting the slurry onto the top surface of the inorganic media.

14. A filter as claimed in claim 12, and wherein the ceramic filtration media is selected from the group consisting essentially of aluminum oxide, titanium oxide, and zirconium oxide.

15. A filter as claimed in claim 12, and wherein the inorganic substrate has a thickness dimension, and wherein the ceramic filtration media is positioned at a depth which is at and/or below the top surface of the inorganic substrate, and which is less that about 20% of the thickness of the inorganic substrate.

16. A filter as claimed in claim 12, and wherein the inorganic substrate has a thickness dimension, and wherein the ceramic filtration media substantially fills the entire thickness dimension of the inorganic substrate.

17. A filter as claimed in claim 12, and wherein the ceramic filtration media is selected from the group comprising a material formed of a single or multiple substantially stable metallic cation species having single or multiple oxide, carbide and/or nitride anion counterparts.

18. A filter as claimed in claim 11, and wherein the inorganic substrate, and the ceramic filtration media each have a toughness characteristic, and wherein the toughness characteristics of the respective inorganic substrate and the ceramic filtration media are chosen so as to provide a resulting filter which impedes the erosion of the ceramic filtration media when the filter is exposed to a feed stream which requires filtration.

19. A filter comprising:
an inorganic substrate having a top surface and a first degree of toughness, and which is fabricated from an inorganic material having particles which have an average size, and which forms a matrix, and wherein the matrix of inorganic material defines a plurality of pores which are located on the top surface of the inorganic substrate, and which have an average pore diameter, and which further facilitates the passage of a fluid to be filtered through the inorganic substrate;
a ceramic filtration media formed of particles having an average size which are smaller than the average pore diameter as defined by the particles forming the inorganic substrate, and which further has a second degree of toughness, and wherein the particles forming the ceramic filtration media are embedded in the pores of the inorganic substrate which are located at the top surface, and wherein the ceramic filtration media fills the pores from a location which is at and/or below the top surface of the inorganic substrate to a distance, and wherein the inorganic substrate substantially impedes the erosion of the ceramic filtration media when the filter is exposed to a feed stream which requires filtration.

20. A filter as claimed in claim 19, and wherein the first degree of toughness is greater than the second degree of toughness.

21. A filter as claimed in claim 19, and wherein the first and second degrees of toughness are chosen so as to provide a resulting filter which impedes the erosion of the ceramic filtration media.

22. A filter as claimed in claim 19, and wherein the inorganic substrate has an amount of ductility, and wherein the ceramic filtration media restrains the amount of ductility expressed by the inorganic substrate.

23. A filter as claimed in claim 19, and wherein the ceramic filtration media is selected from the group comprising a material formed of a single or multiple substantially stable metallic cation species having single or multiple oxide, carbide and/or nitride anion counterparts.

24. A filter as claimed in claim 19, and wherein the inorganic substrate has a predetermined thickness dimension, and wherein the ceramic filtration media is positioned at a depth which is at and/or below the top surface, and which is less than about 20% of the predetermined thickness dimension.

25. A filter as claimed in claim 19, and wherein the inorganic substrate has a predetermined thickness dimension, and wherein the ceramic filtration media penetrates to depth which is at and/or below the top surface of the inorganic substrate, and which is at least a preponderance of the predetermined thickness dimension.

26. A filter as claimed in claim 19, and wherein the inorganic substrate has a first degree of ductility, and wherein the embedded ceramic filtration media restrains the first degree of ductility which is expressed by the inorganic substrate when the filter is exposed to the feed stream which requires filtration.

27. A method of forming a filter, comprising:
providing an inorganic substrate having a first toughness and which will resist degradation when exposed to a fluid to be filtered, and wherein the inorganic substrate is further defined by a top surface; and
embedding a ceramic filtration media having a second toughness into the inorganic substrate so as to substantially inhibit the degradation of the ceramic filtration media when the filter is exposed to the fluid to be filtered.

28. A method as claimed in claim 27, and wherein the step of embedding the ceramic filtration media further comprises:
selecting a ceramic filtration media having a particle size which will pass into the inorganic substrate;
forming a slurry of the of ceramic filtration media; and
casting the slurry onto the top surface of the inorganic substrate under conditions which facilitate the penetration of ceramic filtration media to a distance below the top surface of the inorganic substrate.

29. A method as claimed in claim 28, and wherein the step of casting the slurry onto the top surface of the inorganic substrate further includes utilizing a casting technique which is selected from the group comprising slip casting, pressure casting and painting.

30. A method as claimed in claim 28, and wherein after the step of casting the slurry onto the top surface of the inorganic substrate, the method further comprises:
drying the inorganic substrate;
removing any excess ceramic filtration media which is located above the top surface of the inorganic substrate; and
exposing the resulting inorganic substrate and embedded ceramic filtration media to a predetermined temperature to effect sintering and/or annealing.

31. A method as claimed in claim 28, and wherein the step of exposing the resulting inorganic substrate and embedded ceramic filtration media to a predetermined temperature further comprises:
supplying a cover gas to the inorganic substrate while the inorganic substrate and the embedded ceramic filtration media are exposed to the temperature which effects sintering and/or annealing.

32. A method as claimed in claim 31, and wherein the cover gas is selected from the group of gasses comprising inert, oxidizing, reducing or combinations thereof.
